(19) United States
(12) Patent Application Publication
(10) Pub. No.: US 2026/0125008 A1
(43) Pub. Date: May 7, 2026

(54) COMBINED TRAILER TOW PORT AND BICYCLE PORT ACESSORY POWER

(71) Applicant: Rivian IP Holdings, LLC, Irvine, CA (US)

(72) Inventors: Sanjeewa Keven Sugatapala, Long Beach, CA (US); Kyle Lobo, Westchester, CA (US); Glenn Morris Feinberg, Carlsbad, CA (US); Joseph Daniel Himmelheber, Redondo Beach, CA (US); Michael James Hibbard, Long Beach, CA (US)

(21) Appl. No.: 19/369,776

(22) Filed: Oct. 27, 2025

Related U.S. Application Data
(60) Provisional application No. 63/716,902, filed on Nov. 6, 2024.

(51) Int. Cl. B60R 16/023; B60D 1/64; B60L 53/16; B60L 53/57

(52) U.S. Cl. CPC B60R 16/0238; B60D 1/64; B60L 53/16; B60L 53/57

(57) ABSTRACT

Systems, methods, and vehicles are disclosed herein. For example, a vehicle may comprise a first port located at an exterior of the vehicle, wherein the first port is of a first form factor, and a second port located at the exterior of the vehicle, wherein the second port is of a second form factor that is different from the first form factor. A controller may comprise a plurality of output wires, wherein at least one of the plurality of output wires is coupled to the first port and the second port. The controller may be configured to detect whether an electrical connector is inserted into the first port or the second port, and select a configuration for controlling the plurality of output wires based on the detecting.

### CROSS-REFERENCE TO RELATED APPLICATIONS

This application claims the benefit of U.S. Provisional Application No. 63/716,902, filed Nov. 6, 2024, the disclosure of which is hereby incorporated by reference herein in its entirety.

### INTRODUCTION

Traditional vehicle designs often face challenges in efficiently integrating multiple power and control systems for towing and rear accessory support, especially when accommodating varying regional standards such as those in the United States (US) and European Union (EU). This results in increased complexity, higher costs, and potential user inconvenience due to the need for separate installations and controls for trailer towing and rear accessory power. Additionally, the lack of a unified system can lead to compatibility issues and reduced functionality, limiting the vehicle's versatility and user experience.

### SUMMARY

As disclosed herein, the present disclosure provides for vehicles, systems, methods, non-transitory computer readable mediums, and apparatuses in which a first port is located at an exterior of the vehicle, wherein the first port is of a first form factor, and in which a second port is located at the exterior of the vehicle, wherein the second port is of a second form factor that is different from the first form factor. A controller may comprise a plurality of output wires, wherein at least one of the plurality of output wires is coupled to the first port and the second port, and wherein the controller is configured to detect whether an electrical connector is inserted into the first port or the second port, and select a configuration for controlling the plurality of output wires based on the detecting.

The controller may be further configured to cause, in response to detecting that the electrical connector is inserted into the first port and based on the selected configuration, electric current to flow to an accessory connected to the first port via the at least one of the plurality of output wires.

The first port may be a 7-pin towing port or a 13-pin towing port.

The controller may be further configured to cause, in response to detecting that the electrical connector is inserted into the second port and based on the selected configuration, electric current to flow to an accessory connected to the second port via the at least one of the plurality of output wires.

The second port may be a bicycle accessory port or a cargo box.

The first port and the second port may be located on a rear portion of the exterior of the vehicle.

The apparatus and/or vehicle may further comprise a third port located at the exterior of the vehicle, wherein the second port is a left-hand side bicycle accessory port, in relation to the rear portion of the exterior of the vehicle, and the third port is a right-hand side bicycle accessory port, in relation to the rear portion of the exterior of the vehicle.

In the vehicle, the controller may comprise a left-side controller and a right-side controller; the left-side controller may be configured to cause electric current to flow to a left-hand side of the accessory, in relation to the rear portion of the vehicle, via a first wire of the plurality of output wires; and the right-side controller may be configured to cause electric current to flow to a right-hand side of the accessory, in relation to the rear portion of the vehicle, via a second wire of the plurality of output wires.

The controller may be further configured to wherein the controller is further configured to cause, in response to detecting that a first electrical connector is inserted into the first port and that a second electrical connector is inserted into the second port, and based on the selected configuration: electric current to flow to an accessory connected to the first port via a first wire of the plurality of output wires; and electric current to flow to an accessory connected to the second port via a second wire of the plurality of output wires.

The controller may receive an indication of an input that is received via a user interface, and may select the configuration further based on receiving the indication of the input.

In some embodiments, the disclosed techniques enable uniquely combining trailer tow and rear bike port power into a single, integrated system that supports both US and EU standards, reducing complexity and enhancing user convenience. In some embodiments, the disclosed techniques provide seamless control and power management through the controller (e.g., right and left zonal controllers of a zonal controller), ensuring compatibility and optimal functionality for both towing and rear accessories. This integrated solution streamlines power and control for both towing and rear accessories, offering enhanced versatility and user convenience while meeting diverse regional standards.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A shows an illustrative vehicle comprising a controller, a first port, and a second port, in accordance with some embodiments of this disclosure.

FIG. 1B shows an illustrative system, in accordance with some embodiments of this disclosure.

FIG. 2 shows an illustrative user interface, in accordance with some embodiments of this disclosure.

FIG. 3 shows illustrative signaling paths between a controller of a vehicle and ports of a vehicle, in accordance with some embodiments of this disclosure.

FIG. 4 shows illustrative signaling paths between a controller of a vehicle and a US towing port of a vehicle, in accordance with some embodiments of this disclosure.

FIG. 5 shows illustrative signaling paths between a controller of a vehicle and an EU towing port of a vehicle, in accordance with some embodiments of this disclosure.

FIG. 6 shows illustrative signaling paths between a controller of a vehicle and bike racks, in accordance with some embodiments of this disclosure.

FIG. 7 shows illustrative signaling paths between a controller of a vehicle and a cargo box, in accordance with some embodiments of this disclosure.

FIG. 8 shows illustrative an illustrative flowchart, in accordance with some embodiments of this disclosure.

FIG. 9 shows an illustrative flowchart, in accordance with some embodiments of this disclosure.

### DETAILED DESCRIPTION

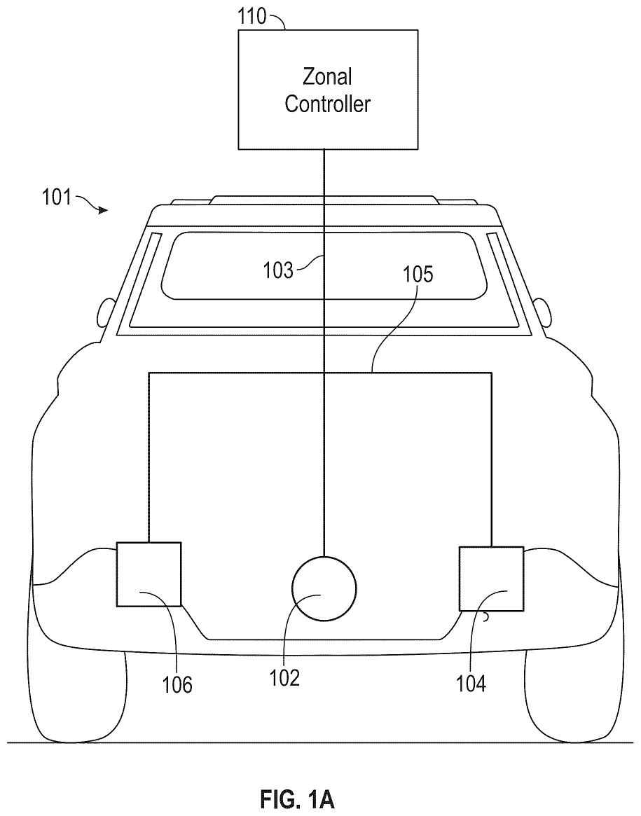

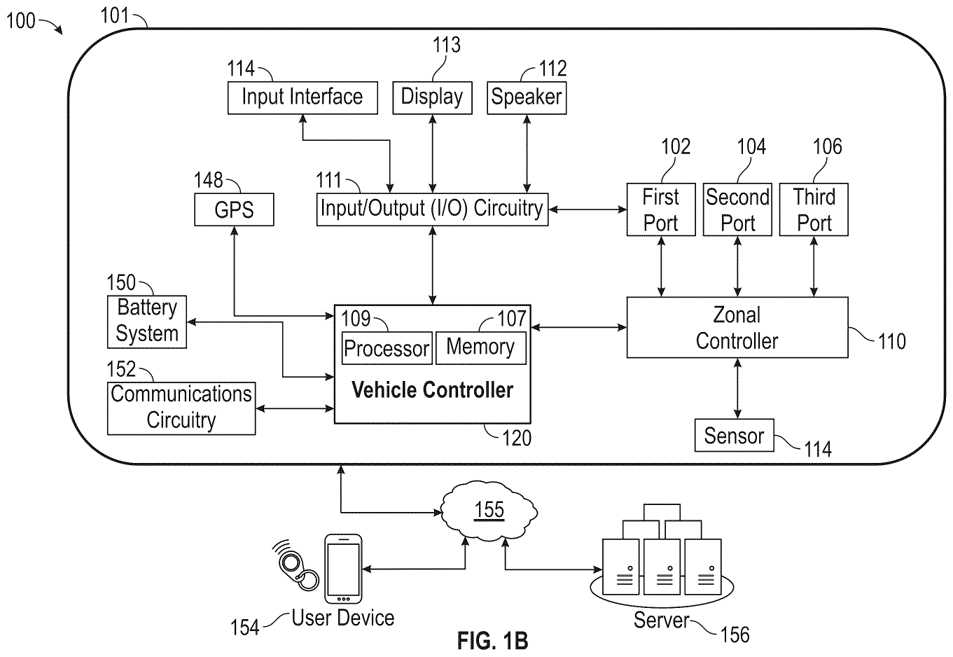

FIG. 1A shows an illustrative vehicle 101 comprising a zonal controller 110, a first port 102, a second port 104, and a third port 106, in accordance with some embodiments of this disclosure. Zonal controller 110 may comprise any suitable combination of hardware and executable instructions to perform the functionalities disclosed herein. Zonal controller may comprise a plurality of output wires, at least one of the plurality of output wires 108 being coupled to the first port 102 and the second port 104 (and/or third port 106). For example, as shown in FIG. 1A, output wire 103 is coupled to output wire 105, and output wire 105 may be coupled to each of first port 102, second port 104, and third port 106. For example, output wire 105 may be a split lead having a current path to multiple ports 102, 104, 106, and/or wires may be connected in a parallel configuration, such that zonal controller 110 may control the plurality of output wires based on a signal output via output wire 103 to output wire 105 and to one or more of ports 102, 104, and 106. In some embodiments, output wires 103 and 105 may be spliced together.

Zonal controller 110 may be configurable to interface with first port 102, a second port 104, and/or third port 106, one or more of which may be of different form factors. For example, first port 102 may be a 7-pin towing port or 7-way towing port (such as for vehicles in the US) or a 13-pin or 13-way towing port (such as for vehicles in the EU) configured to enable vehicle 101 to provide electric power to an accessory, e.g., a vehicle being towed by vehicle 101, such as, for example, a trailer, a boat, a vehicle, a motorcycle, or any other suitable towable accessory, or any suitable combination thereof. First port 102 may be located on a rear portion of an exterior of vehicle 101, e.g., at or near a trailer hitch or rear bumper of vehicle 101. Second port 104 may be a right-hand side bike accessory port, and third port 106 may be a left-hand side bike accessory port. In some embodiments, a single port may be used for the bike accessory port, instead of second port 104 and third port 106, e.g., second port 104 may provide the pinouts for utilizing each of the functionalities provided via the bike accessory port.

In some embodiments, 7-pin towing port or 7-way towing port supports trailer lighting, 25A for auxiliary power, and 2-axle (16A) trailer brake, and/or any other suitable functionality. In some embodiments, 13-pin or 13-way towing port supports trailer lighting, 25A for auxiliary power, but does not support trailer braking, and/or supports any other suitable functionality. In some embodiments, the bike port receiver (or port for other suitable purpose, e.g., a portable kitchen or cooking station, a shower, a wheel lift, a winch, a power adapter, a computer station, lighting, a fan, a solar panel, a cooler, a generator, any other suitable accessory, or any suitable combination thereof) supports rear lighting and 25A for auxiliary power for rear accessories, applicable to both EU and US variants, and/or supports any other suitable functionality.

In some embodiments, trailer tow and rear bike port power are combined (due to overlapping requirements/needs/features). The trailer tow supports the towing feature requirements for both the US and EU, or for the appropriate location (e.g., where vehicle 101 is to be used), as well as bike port receivers (or other suitable ports or receivers) based on receiving power via a shared wire (e.g., wire 105) which may be directly or indirectly coupled to zonal controller 110. Such ports may be located in the rear of the vehicle 101 and support the powering of lights and exportable power to trailer port and/or bicycle port.

Zonal controller 110 may comprise or otherwise be coupled to one or more sensors, such as, for example, sensor 114 of FIG. 1B, and may receive sensor data from such one or more sensors indicating whether one or more electrical connectors (e.g., cable(s), wire(s), plug(s), socket(s), and/or harness(es)) are connected to one or more of first port 102, second port 104, and/or third port 106. Wires 103, 105 and/or the electrical connector may each be an insulated wire or set of insulated wires bound together, and may incorporate protective material such as, for example, metal sheathing. Based on sensor data received from sensor 114, zonal controller 110 may select a configuration for controlling the plurality of output wires 103, 105 based on such sensor data.

For example, zonal controller 110 may determine that, for example, a first electrical connector is inserted into first port 102, e.g., a cable or harness connected to a trailer to be towed by vehicle 101 is coupled to first port 102, and based on such sensor data, zonal controller 110 may cause electric current to flow to first port 102 via output wire 105. On the other hand, zonal controller 110 may determine that, for example, a first electrical connector is inserted into second port 104 and/or third port 106, e.g., a cable or harness of a bike rack to be used to charge an electric bicycle, and based on such sensor data, zonal controller 110 may cause electric current to flow to second port 104 and/or third port 106 via output wire 105.

In some embodiments, upon detecting that an electrical connector is connected to each of first port 102 and second port 104 (and/or third port 106), zonal controller 110 may cause electric current to be simultaneously provided to each of first port 102 and second port 104 (and/or third port 106), via wire 103 and wire 105. For example, zonal controller 110 may cause a signal to split between the various ports 102, 104, and 106.

FIG. 1B shows a system 100 comprising electric vehicle 101, in accordance with some embodiments of this disclosure. Vehicle 101 may be a car (e.g., a coupe, a sedan, a truck, an SUV, a bus), a motorcycle, an aircraft (e.g., a drone), a watercraft (e.g., a boat), or any other type of vehicle, or any combination thereof. Zonal controller 110 described in FIG. 1A may be in communication with first port 102, second port 104, and third port 106, as well as sensor 114, and vehicle controller 120. In some embodiments, zonal controller 110 may be implemented in a similar manner as vehicle controller 120, e.g., zonal controller 110 may similarly comprise a processor and memory as described below, and/or other suitable components. In some embodiments, zonal controller 110 may be configured to control a sub-portion of vehicle 101 (e.g., provision of electricity to ports on a rear of vehicle), and vehicle controller 120 may control and communicate with a wider array of vehicle components.

Vehicle controller 120 may comprise processor 109 and memory 107. Processor 109 of vehicle controller 120 may comprise a hardware processor, a software processor (e.g., a processor emulated using a virtual machine), or any combination thereof. In some embodiments, processor 109 and memory 107 in combination may be referred to as vehicle controller 120 of vehicle 101. In some embodiments, processor 109 alone may be referred to as controller vehicle of vehicle 101. Memory 107 may comprise hardware elements for non-transitory storage of commands or instructions, that, when executed by processor 109, cause processor 109 to operate vehicle 101 in accordance with embodiments described above and below. Vehicle controller 120 may be communicatively connected to components of vehicle 101 and system 100 via one or more wires, or via wireless connection. In some embodiments, memory 107 may be configured to store electronic data, computer software, or firmware, and may include random-access memory, read-only memory, hard drives, optical drives, solid state devices, or any other suitable fixed or removable storage devices, and/or any combination of the same. Nonvolatile memory may also be used (e.g., to launch a boot-up routine and other instructions). In some embodiments, vehicle controller 120 may include or be in communication with other processing circuitry in vehicle 101 (e.g., an electronic control unit (ECU) of vehicle 101), which may be configured to communicate with other portions of vehicle 101 and perform various tasks.

In some embodiments, vehicle may include one or more microprocessors, microcontrollers, digital signal processors, programmable logic devices, field programmable gate arrays (FPGAs), application-specific integrated circuits (ASICs), etc., and may include a multi-core processor. In some embodiments, vehicle controller 120 may be distributed across multiple separate processors or processing units, for example, multiple of the same type of processing units or multiple different processors.

Vehicle controller 120 may be communicatively connected to electric battery system 150, which may be configured to provide power to one or more of the components of vehicle 101 during operation. In some embodiments, vehicle 101 may be an electric vehicle or a hybrid electric vehicle. Electric battery system 150 may include one or more battery modules, e.g., a 180 kWh battery pack or a 135 kWh battery pack. Vehicle controller 120 may manage the flow of electricity to electric battery system 150 (e.g., to perform AC-DC conversion when the battery of vehicle 101 is charged with an AC charger), and any other suitable components. Vehicle controller 120 may be configured to manage current flow to provide electric power to ports 102, 104, and 106. Vehicle controller 120 may include or monitor, for example, electrical components (e.g., switches, bus bars, resistors, capacitors), control circuitry (e.g., for controlling suitable electrical components), and measurement equipment (e.g., to measure voltage, current, impedance, frequency, temperature, or another parameter).

Vehicle controller 120 may further include or be in communication with communications circuitry 152 and input/output (I/O) circuitry 111. I/O circuitry 111 may be communicatively connected to display 113, input interface 114, and speaker 112. Display 113 may be located at a dashboard of vehicle 101 and/or a heads-up display at a windshield of vehicle 101. For example, a notification regarding the detection of an electronic connector in one or more of port 102, 104, or 106 may be generated for display and/or otherwise generated for output (e.g., audio notification via speaker 112). Display 113 may comprise an LCD display, an OLED display, an LED display, and/or any other type of display. Speaker 112 may be located at any location within the cabin of vehicle 101, e.g., at the dashboard of vehicle 101, on an interior portion of the vehicle door. In some embodiments, haptic notification may be provided to notify an operator and/or passenger of electric vehicle 101 of the detected electrical connector at one or more of ports 102, 104, or 106. In some embodiments, the notification may be provided to user device 154 (e.g., a mobile device, such as, for example, a smartphone or a tablet or a key fob, such as via wireless or wired communication), in addition to or alternative to display 113 and speaker 112 within electric vehicle 101.

In some embodiments, zonal controller 110 may be in communication (e.g., via communications circuitry 152) with user device 154 (e.g., a mobile device, a computer, a key fob, etc.). Such connection may be wired or wireless. In some embodiments, communications circuitry 906 and/or user device 918 may be in communication with a server 156 (e.g., over a communications network 155, such as, for example, the Internet, and/or a cellular telephone network and/or a satellite network and/or any other suitable network or communication technique), to transmit or receive information regarding ports 102, 104, or 106 and/or type of electrical connectors inserted or to be inserted therein.

It should be appreciated that FIG. 1B only shows some of the components of vehicle 101, and it will be understood that vehicle 101 also includes other elements commonly found in vehicles (e.g., electric vehicles), e.g., a motor, brakes, wheels, wheel controls, turn signals, windows, doors, etc.

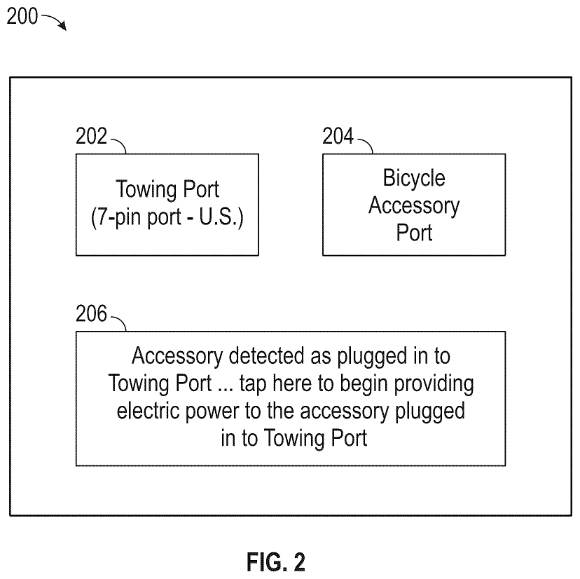

FIG. 2 shows an illustrative user interface 200, in accordance with some embodiments of this disclosure. UI 200 may be provided, e.g., via vehicle controller 120 and/or I/O circuitry 111 (FIG. 1B), such as, for example, at a display 113 of vehicle 101 or via a display of a user device 154 (FIG. 1B), and/or at user device 152 of FIG. 1B. In some embodiments, selecting the configuration for controlling the plurality of output wires is further based on receiving an indication (e.g., at zonal controller 110) that input has been received at UI 200.

For example, as shown in FIG. 2, UI 200 may be caused to comprise UI elements 202, 204, and 206. UI elements 202 and 204 may indicate the types of ports on a rear exterior of vehicle 101, e.g., a 7-pin port for US towing connections and bicycle accessory port, respectively. In some embodiments, UI element 202 and/or UI element 204 may be selectable to access additional information related to the type of port, e.g., a pinout diagram or what functions (e.g., lights, charging) are supported by way of the respective port. UI element 206 may be a notification indicating that a particular port, e.g., first port 102 of FIGS. 1A-1B, is detected as having an electrical connector inserted therein, and UI element 206 may be selectable to, e.g., instruct zonal controller 110 to commence providing electric power to such first port 102. In some embodiments, auxiliary power may be switchable via the UI, rather than being enabled automatically; on the other hand, in some embodiments, the auxiliary power may be enabled automatically for a particular port, e.g., upon detecting an electrical connector inserted into the particular port. In some embodiments, the towing port may be a factory-installed feature, and/or a 4-way towing port may be usable by way of a harness adapter. In some embodiments, zonal controller 110 may automatically select a configuration for controlling the plurality of output wires based on detecting the insertions of the electrical connector into one or more ports, without reference to whether UI inputs are received by way of UI 200.

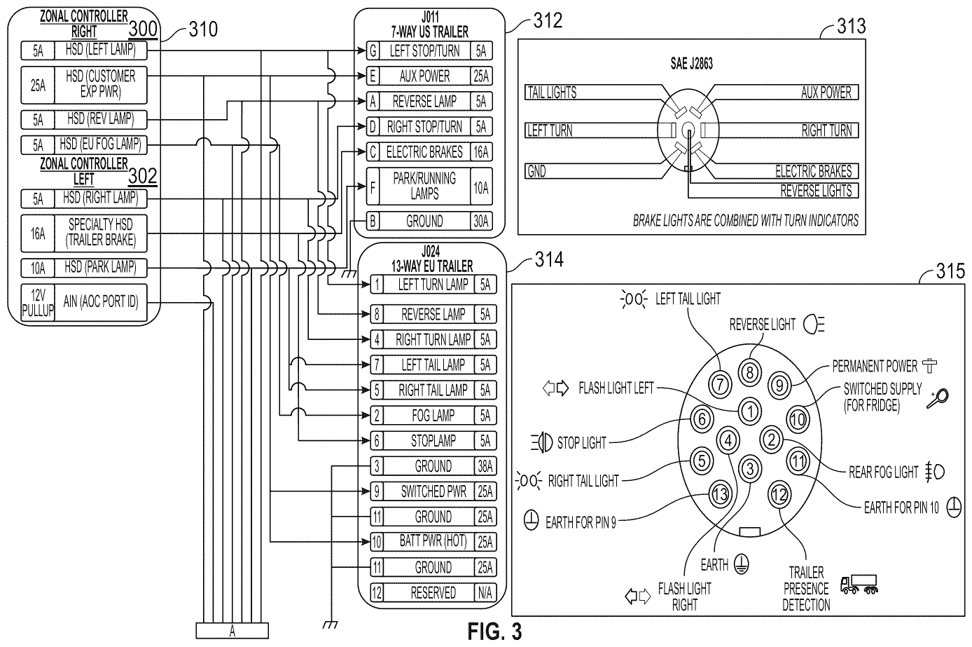

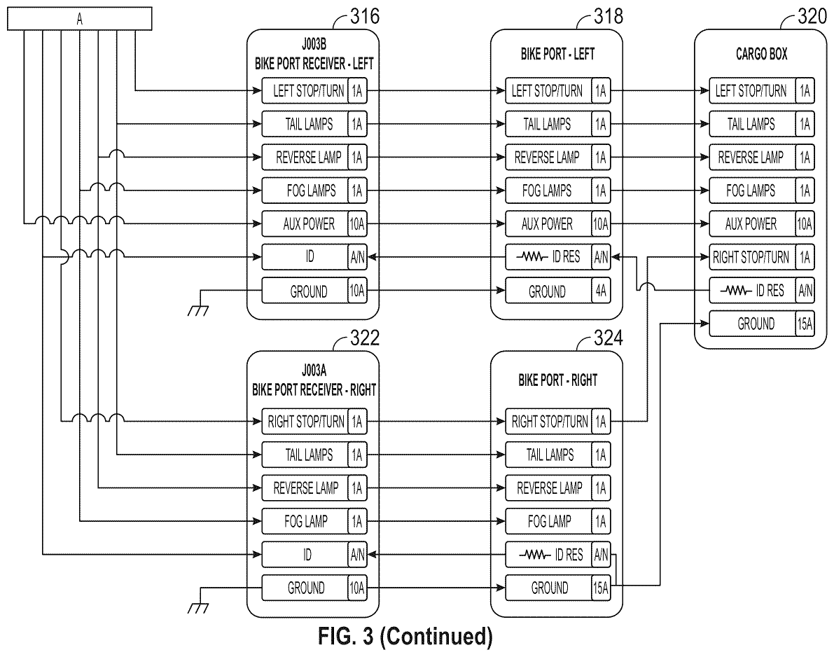

FIG. 3 shows illustrative signaling paths between a controller of a vehicle and ports of a vehicle, in accordance with some embodiments of this disclosure. In some embodiments, zonal controller 310 (which may correspond to zonal controller 110) may comprise right-hand side zonal controller 300 and left-hand side zonal controller 302, in a dual controller implementation. For example, right-hand side zonal controller 300 may be configured to control a right-hand side of a rear of an exterior of a vehicle, and the left-hand side zonal controller 302 may be configured to control flow of electric current to a left-hand side of a rear of an exterior of a vehicle. In some embodiments, right-hand side zonal controller 300 and left-hand side zonal controller 302 may be different portions (e.g., different sides) of the same zonal controller 310.

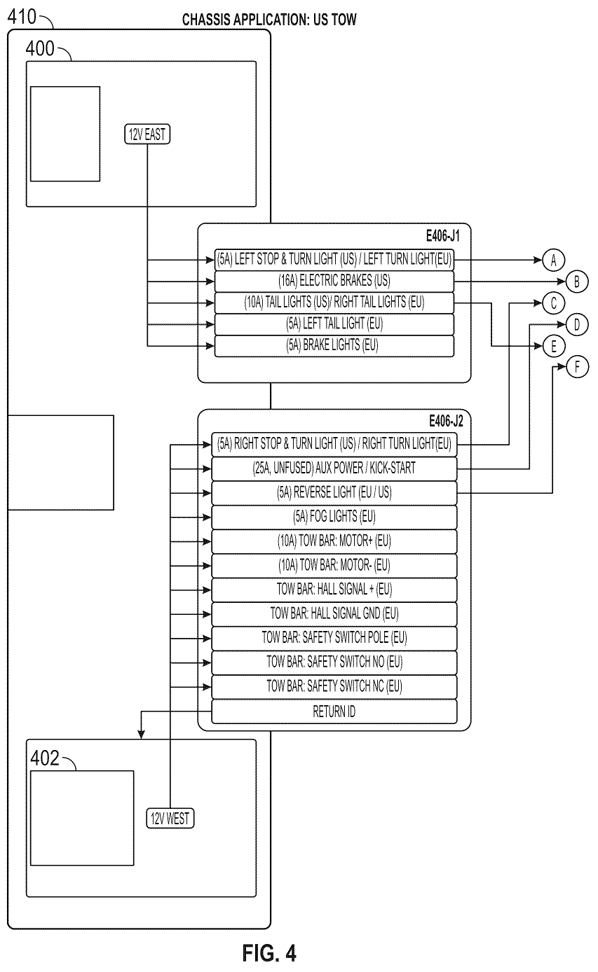

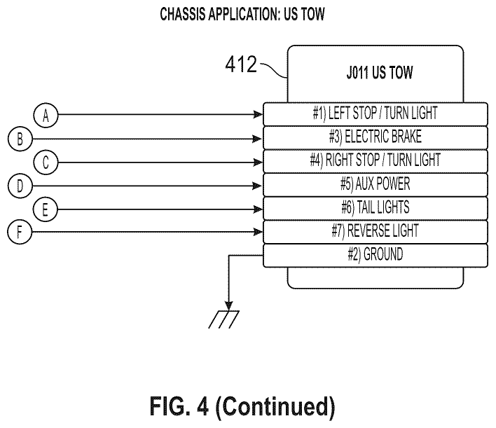

Zonal controller right 300 and zonal controller left 302 may comprise a plurality of pins or electrical contacts configured to provide signals to corresponding pins of one or more ports of vehicle 101. 313 shows the function of each pin of a port implemented in accordance with the SAE J2863 standard for 7-way US trailer port 312 (which may correspond to the first port 102, in some embodiments). 315 shows the function of each pin of a port implemented in accordance with the ISO11446 standard for 13-way EU trailer port 314 (which may correspond to the first port 102, in some embodiments). In some embodiments, zonal controller 310 may determine whether an electrical connector is inserted in a particular port (and/or a type of electrical connector and/or a type of accessory connected) based on, e.g., a resistance measurement at 7-way US trailer port 312 or 13-way EU trailer port 314. In some embodiments, the vehicle only includes one of 7-way US trailer port 312 or 13-way EU trailer port 314, and a bike port accessory (e.g., cargo box 320, bike ports 318 and 324, bike port receivers 316 and 422 of FIG. 4) or other suitable accessory may be simultaneously connected to the vehicle, where power may be provided to each accessory connected to the towing port and the bike port.

As shown in FIG. 3, high-side detect (HSD) left lamp (tail light) element of zonal controller right 300 may provide a signal (e.g., 5 amps of electric current) to pin G (left stop/turn) of 7-way US trailer port 312 (which may correspond to the first port 102, in some embodiments), or, in the EU implementation, 13-way EU trailer port 314 (which may correspond to the first port 102, in some embodiments), HSD (left lamp) may provide a signal to pin 1 (left turn lamp). HSD (customer exportable power) of zonal controller right 300 may provide a signal (e.g., 25 amps) to pin E (auxiliary power) of 7-way US trailer port 312, or pin 9 (switched power) and pin 10 (battery power (hot)) of 13-way US trailer port 314. HSD (reverse taillight lamp) element of controller 300 may provide a signal (e.g., 5 amps) to pin A (reverse tail light lamp) of 7-way US trailer port 312, or pin 8 (reverse tail light lamp) of 13-way EU trailer port 314. HSD (EU fog lamp) element of zonal controller right 300 may provide a signal (e.g., 5 amps) to pin 2 (fog lamp) of 13-way EU trailer port 314.

As shown in FIG. 3, HSD right tail light lamp element of zonal controller left 302 may provide a signal (e.g., 5 amps) to pin D (right/stop turn) of 7-way US trailer port 312, or may provide a signal (e.g., 5 amps) to pin 4 (right turn tail light lamp) of 13-way EU trailer port 314. Zonal controller left 302 may provide a signal (16 A) from specialty HSD (trailer brake) element to pin C (electric brakes) of 7-way US trailer port 312, or may provide a signal (16 A) to stop pin 6 (stop lamp) of 13-way EU trailer port 314. Zonal controller left 302 may provide a signal (e.g., 10 amps) from HSD (park lamp) to pin F (park/running lamps) of 7-way US trailer port 312, or may provide a signal (e.g., 5 amps) from HSD (park lamp) to pins 7 (left tail lamp) and 5(right tail lamp) of 13-way EU trailer port 314.

HSD (left lamp) element of zonal controller right 300 may provide a signal (e.g., 5 amps) to left stop/turn element of bike port receiver (left) 316. HSD (park lamp) of zonal controller left 302 may provide a signal (e.g., 10 amps) to the tail lamps pin of bike port receiver (left) 316. HSD (reverse lamp) element of zonal controller right 300 may provide a signal (e.g., 5 amps) to the reverse lamp pin of bike port receiver (left) 316. HSD (EU fog lamp) element may provide a signal (e.g., 5 amps) to the fog lamps pin of bike port receiver (left) 316. HSD (customer exportable power) element of zonal controller right 300 may provide a signal (e.g., 5 amps) to the auxiliary power pin of bike port receiver (left) 316. Accessory identification input (AIN) element of zonal controller left 302 may provide a signal (e.g., 12 V pullup) to ID pin of bike port receiver (left) 316. The elements of bike port receiver (left) 316 may be in communication with corresponding elements of bike port (left) 318, which in turn may be in communication with corresponding portions of cargo box 320.

Zonal controller right 300 may provide a signal (e.g., 5 amps) from HSD (right lamp) element to the right stop/turn pin of bike port receiver (right) 322. Zonal controller right 300 may provide a signal (e.g., 10 amps) from HSD (park lamp) element to the tail lamps pin of bike port receiver (right) 322. HSD (reverse lamp) element of zonal controller right 300 may provide a signal (e.g., 5 amps) to the reverse lamp pin of bike port receiver (right) 322. HSD (EU fog lamp) may provide a signal (e.g., 5 amps) to the fog lamps pin of bike port receiver (right) 322. Accessory identification input (AIN) element of zonal controller left 302 may provide a signal (e.g., 12 V pullup) to the ID pin of bike port receiver (right) 322. The elements of bike port receiver (right) 322 may be in communication with corresponding elements of bike port (left) 324, certain elements of which (e.g., right stop/turn element and ground element) may be in communication with corresponding elements of cargo box 320.

7-way US trailer port 312 may provide a voltage of 9.0 V-16.0 V, and may provide a power of 360 W, and 13-way EU trailer port 314 may provide a voltage of 9.0 V-16.0 V. Electric bike rack (e.g., 316, 318, 322, 324) may provide a voltage of 9.0 V-16.0 V, and may provide a power of 300 W.

In some embodiments, HSD left lamp element of zonal controller right 300 may have a steady-state current of 5 amps, where lighting provided via the left lamp should not exceed the steady-state current. The HSD left lamp element of zonal controller right 300 may be used to help perform detection of whether a trailer is plugged into the towing port. In some embodiments, the HSD left lamp element of zonal controller right 300 may be configured to handle a resistive or capacitive load, and may allow for in-rush capabilities (e.g., if trailer lamps are LEDs or incandescent bulbs having in-rush like effects). In some embodiments, the HSD left lamp element of zonal controller right 300 may provide for back-feeding protection, may provide for parking, trailer towing, dynamic driving, braking, and/or other suitable functionalities for a towed vehicle, and may be controlled by way of zonal controller right 300, or any other suitable portion of zonal controller 310.

In some embodiments, the HSD right lamp element of zonal controller left 302 may have a steady-state current of 5 amps, where lighting provided via the left lamp should not exceed the steady-state current. The HSD right lamp element may be used to help perform detection of whether a trailer is plugged into the towing port. In some embodiments, HSD right lamp element of zonal controller left 302 may be configured to handle a resistive or capacitive load, and may allow for in-rush capabilities (e.g., if trailer lamps are LEDs or incandescent bulbs having in-rush like effects). In some embodiments, the HSD right lamp element of zonal controller right 300 may provide for back-feeding protection, may provide for parking, trailer towing, dynamic driving, braking, and/or other suitable functionalities for a towed vehicle, and may be controlled by way of zonal controller left 302, or any other suitable portion of zonal controller 310.

In some embodiments, the HSD reverse lamp element of zonal controller right 300 may have a steady-state current of 5 amps, where lighting provided via the left lamp should not exceed the steady-state current. The HSD reverse lamp may be used to help perform detection of whether a trailer is plugged into the towing port. In some embodiments, HSD reverse lamp of zonal controller right 300 may be configured to handle a resistive or capacitive load, and may allow for in-rush capabilities (e.g., if trailer lamps are LEDs or incandescent bulbs having in-rush like effects). In some embodiments, HSD reverse lamp of zonal controller right 300 may provide for back-feeding protection, may provide for parking, trailer towing, dynamic driving, braking, and/or other suitable functionalities for a towed vehicle, and may be controlled by way of zonal controller right 300, or any other suitable portion of zonal controller 310.

In some embodiments, the HSD park lamp element of zonal controller left 302 may have a steady-state current of 5 amps, where lighting provided via the left lamp should not exceed the steady-state current. The HSD park lamp element of zonal controller left 302 may be used to help perform detection of whether a trailer is plugged into the towing port. In some embodiments, the HSD park lamp element of zonal controller right 300 may be configured to handle a resistive or capacitive load, and may allow for in-rush capabilities (e.g., if trailer lamps are LEDs or incandescent bulbs having in-rush like effects). In some embodiments, the HSD park lamp element of zonal controller right 300 may provide for back-feeding protection, may provide for parking, trailer towing, dynamic driving, braking, and/or other suitable functionalities for a towed vehicle, and may be controlled by way of zonal controller left 302, or any other suitable portion of zonal controller 310.

In some embodiments, the HSD fog lamp element of zonal controller right 300 may have a steady-state current of 5 amps, where lighting provided via the left lamp should not exceed the steady-state current. The HSD fog lamp element of zonal controller right 300 may be used to help perform detection of whether a trailer is plugged into the towing port. In some embodiments, the HSD fog lamp element of zonal controller right 300 may be configured to handle a resistive or capacitive load, and may allow for in-rush capabilities (e.g., if trailer lamps are LEDs or incandescent bulbs having in-rush like effects). In some embodiments, the HSD fog lamp element of zonal controller right 300 may provide for back-feeding protection, may provide for parking, trailer towing, dynamic driving, braking, and/or other suitable functionalities for a towed vehicle, and may be controlled by way of zonal controller left 302, or any other suitable portion of zonal controller 310.

In some embodiments, the HSD/specialty (trailer brake) circuit of zonal controller left 302 may be utilized for at least two different functions, depending on the EU versus US trailer port configuration. In the US configuration, the circuit may be used as a brake controller controlling up to 2-axle trailer brakes. In the EU, this circuit may be repurposed to provide the stop lamp power. The EU stop lamp power has a lower power requirement and thus may require i2t depending on the wire size used in EU trailer tow harness. The HSD/specialty (trailer brake) circuit may have a steady-state current of 16 A for the US trailer brake, and 5 amps for the EU stop lamp. In some embodiments, pulse width modulation (PWM) may be employed in the US implementation to modulate the gain/power to the trailer brakes. The EU stop lamp may employ the PWM set to 100%. The HSD/specialty trailer brake may be used to help perform trailer detection, and may be used to determine if trailer brakes are present (which may be indicated on the UI) in the US configuration. The EU stop lamp may use 5 amps, and depending on the harness selected, may utilize additional i2t requirements. The load type for the HSD/specialty (trailer brake) may include 3 brake sets per axle, and may provide for parking, trailer towing, dynamic driving, braking, and/or other suitable functionalities for a towed vehicle.

AIN of zonal controller left 302 may utilize, e.g., a sampling rate of 1 Hz, as the signal to detect the presence of an electrical connector may be static, and AIN of zonal controller left 302 may have the ability to detect different accessory connections. AIN of zonal controller left 302 may employ a wetting current of 2 mA, in some embodiments. A device identification for the bike port/cargo box may be received through one or more of the bike port receivers 316 and 322. In some embodiments, a trailer port adapter may be used instead of the bike port receivers, e.g., terminal position assurance (TPA) and/or connector position assurance (CPA) may be employed, or a certain ingress protection (IP) connector rating, and device identification may be performed based on, e.g., current measurement.

In some embodiments, if a single ground return line on a port exceeds 40 amps, a ranking of load shedding priority, until the return line returns to less than 30 A (to make the brake circuit functional again), may be as follows: aux power, tail/park lamp, reverse lamp, right turn/stop lamp, left turn/stop lamp, and brake power. In some embodiments, auxiliary reverse polarity prosecution may be implemented using the HSD with a diode or ideal MOSFET or HSD with fuse.

FIG. 4 shows illustrative signaling paths between a controller of a vehicle and a US towing port of a vehicle, in accordance with some embodiments of this disclosure. As shown in FIG. 4, zonal controller 410 may comprise zonal controller right 400 and zonal controller left 402. In some embodiments, zonal controller 410 may correspond to zonal controller 310 of FIG. 3, zonal controller right 400 may correspond to zonal controller right 300 of FIG. 3, and zonal controller left 402 may correspond to zonal controller left 302 of FIG. 3.

Zonal controller right 400 may provide a signal (e.g., 5 amps) from left stop and turn light element (US) to pin 1 (left stop/turn light pin) of J011 US tow 412.

Zonal controller right 400 may provide a signal (e.g., 16 amps) from electric brakes element (US) to pin 3 (electric brake pin) of J011 US tow 412. Zonal controller right 400 may provide a signal (e.g., 10 amps) from a taillight element (US) to pin 6 (the tail light pin) of J011 US tow 412.

Zonal controller right 402 may provide a signal (e.g., 5 amps) from right stop and turn light element (US) to pin 4 (right stop/turn light) of J011 US tow 412. Zonal controller right 402 may provide a signal (e.g., 25 amps, unfused) from auxiliary power/kick-start element (US) to pin 5 (auxiliary power pin) of J011 US tow 412. Zonal controller right 402 may provide a signal (e.g., 5 amps) from the reverse light element (US) to pin 7 (reverse light pin) of J011 US tow 412.

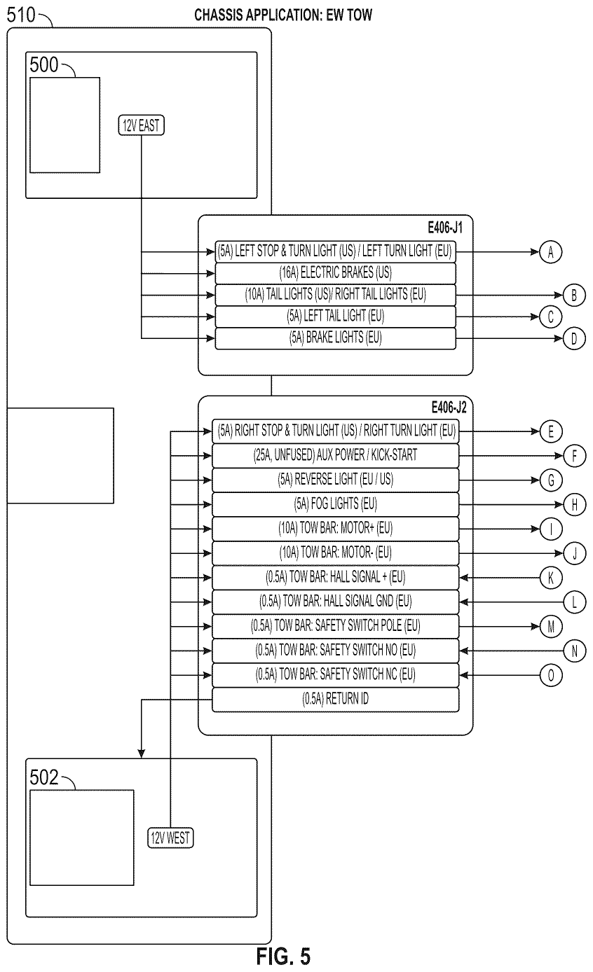

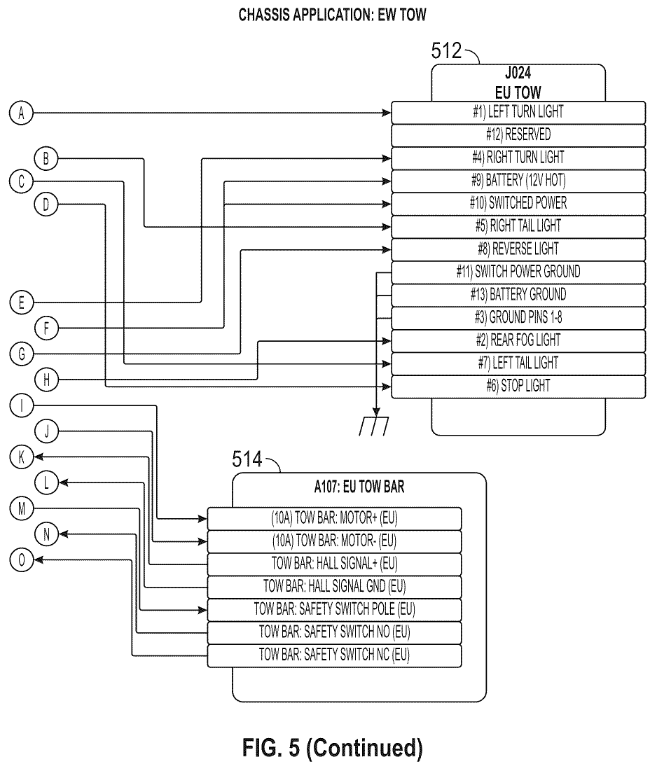

FIG. 5 shows illustrative signaling paths between a controller of a vehicle and an EU towing port of a vehicle, in accordance with some embodiments of this disclosure. As shown in FIG. 5, zonal controller 510 may comprise zonal controller right 500 and zonal controller left 502. In some embodiments, zonal controller 510 may correspond to zonal controller 310 of FIG. 3, zonal controller right 500 may correspond to zonal controller right 300 of FIG. 3, and zonal controller left 502 may correspond to zonal controller left 302 of FIG. 3.

Zonal controller right 500 may provide a signal (e.g., 5 amps) from left turn light element (EU) to pin 1 (left turn light) of J024 EU tow 512. Zonal controller right 500 may provide a signal (e.g., 10 amps) from right taillights element (EU) to pin 4 (right tail light pin) of J024 EU tow 512. Zonal controller right 500 may provide a signal (e.g., 5 amps) from left taillights element (EU) to pin 7 (left tail light pin) of J024 EU tow 512. Zonal controller right 500 may provide a signal (e.g., 5 amps) from brake lights element (EU) to pin 6 (stop light) of J024 EU tow 512.

Zonal controller left 502 may provide a signal (e.g., 5 amps) from right turn light element to pin 4 (right stop/turn light pin) of J024 EU tow 512. Zonal controller left 502 may provide a signal (e.g., 25 amps, unfused) from auxiliary power/kick-start element to pins 9 and 10 (battery (12 V hot) and switched power pins, respectively) of J024 EU tow 512. Zonal controller left 502 may provide a signal (e.g., 5 amps) from a reverse light element to pin 8 (reverse light pin) of J024 EU tow 512. Zonal controller left 502 may provide a signal (e.g., 5 amps) from a fog light element to pin 2 (rear fog light pin) of J024 EU tow 512.

Zonal controller left 502 may provide a signal (e.g., 10 amps) from a tow bar: motor+element (EU) to a tow bar: motor+element (EU) of A107 EU tow bar 514. Zonal controller left 502 may provide a signal (e.g., 10 amps) from a tow bar: motor-element (EU) to a tow bar: motor-element (EU) of A107 EU tow bar 514. Zonal controller left 502 may receive a signal (e.g., 0.5 amps) from a tow bar: hall signal+(EU) to a tow bar: motor-element (EU) of A107 EU tow bar 514. Tow bar: hall signal ground (EU) may be connected to tow bar: hall signal ground (EU) of A107 EU tow bar 514. Zonal controller left 502 may provide a signal (e.g., 0.5 amps) between tow bar: safety switch pole (EU) and tow bar: safety switch pole (EU) of A107 EU tow bar 514. Tow bar: safety switch NO (EU) element of zonal controller left 502 may receive a signal (e.g., 0.5 amps) from tow bar: safety switch NO (EU) element A107 EU tow bar 514, and tow bar: safety switch NC (EU) element of zonal controller left 502 may receive a signal (e.g., 0.5 amps) from tow bar: safety switch NC (EU) element A107 EU tow bar 514

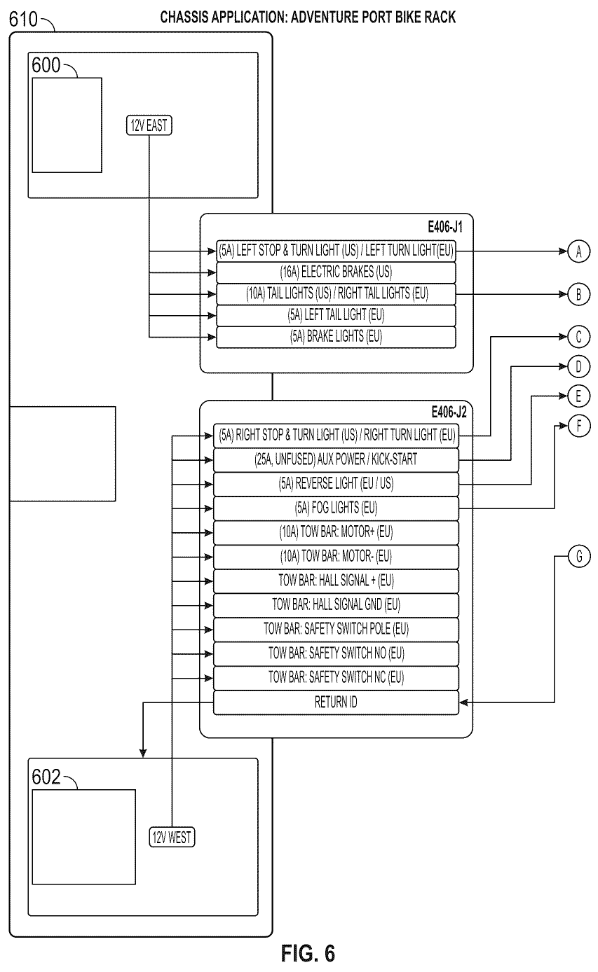

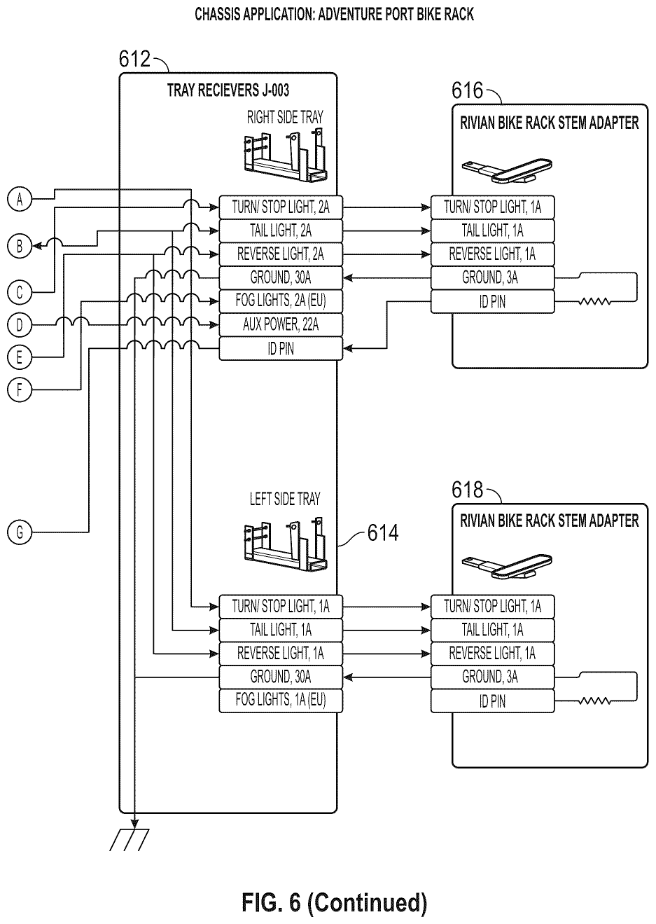

FIG. 6 shows illustrative signaling paths between a controller of a vehicle and bike racks, in accordance with some embodiments of this disclosure. As shown in FIG. 6, zonal controller 610 may comprise zonal controller right 600 and zonal controller left 602. In some embodiments, zonal controller 610 may correspond to zonal controller 310 of FIG. 3, zonal controller right 600 may correspond to zonal controller right 300 of FIG. 3, and zonal controller left 602 may correspond to zonal controller left 302 of FIG. 3. As shown in FIG. 6, tray receivers 612 and 614 may provide an interface between zonal controller 610 and bike rack stem adapters 616 and 618, respectively. For example, tray receivers 612 and 614 may plug into respective ports of the vehicle.

In the US implementation, zonal controller right 600 may provide a signal (e.g. 5 amps) from the left stop and turn light element to turn/stop light element of left-side tray 614; zonal controller right 600 may provide a signal (e.g. 10 amps) from the tail lights element to tail light element of right-side tray 612 and to tail light element of left-side tray 614; zonal controller left 602 may provide a signal (e.g., 5 amps) from the right stop and turn light elements to turn/stop light element of right-side tray 612; zonal controller left 602 may provide a signal (e.g., 25 A, unfused) from the auxiliary power/kick-start element to auxiliary power (e.g., 22 A) element of right-side tray 612; zonal controller left 602 may provide a signal (e.g., 5 A) from the reverse light element to reverse light elements of right-side tray 612 and left-side tray 614; and zonal controller left 602 may receive an identification signal (e.g., of bike rack stem adapter 616) from the ID pin of right-side tray 612.

In the EU implementation, zonal controller right 600 may provide a signal (e.g. 5 amps) from the left turn light element to turn/stop light element of left-side tray 614; zonal controller right 600 may provide a signal (e.g. 10 amps) from the right tail lights element to tail light element of right-side tray 612 and to tail light element of left-side tray 614; zonal controller left 602 may provide a signal (e.g., 5 amps) from the right turn light element to turn/stop light element of right-side tray 612; zonal controller left 602 may provide a signal (e.g., 25 A, unfused) from the auxiliary power/kick-start element to auxiliary power (e.g., 22 A) element of right-side tray 612; zonal controller left 602 may provide a signal (e.g., 5 A) from the reverse light element to reverse light elements of right-side tray 612 and left-side tray 614; zonal controller left 602 may provide a signal (e.g., 5 amps) from its fog lights element to the fog lights element of right-side tray 612; and zonal controller left 602 may receive an identification signal (e.g., of bike rack stem adapter 616) from the ID pin of right-side tray 612.

As shown in FIG. 6, the corresponding elements or pins of right-side tray 612 and left-side tray 614 may be coupled to the corresponding pins of bike rack stem adapter 616 and bike rack stem adapter 618, respectively. For example, this may allow power to be provided to bike rack stem adapters 616 and 618, e.g., to provide turn/stop lights and taillights, reverse lights, and/or other functionalities. For example, this may be beneficial if the bike rack is at least partially occluding the taillights of the vehicle to which it is connected and mounted on.

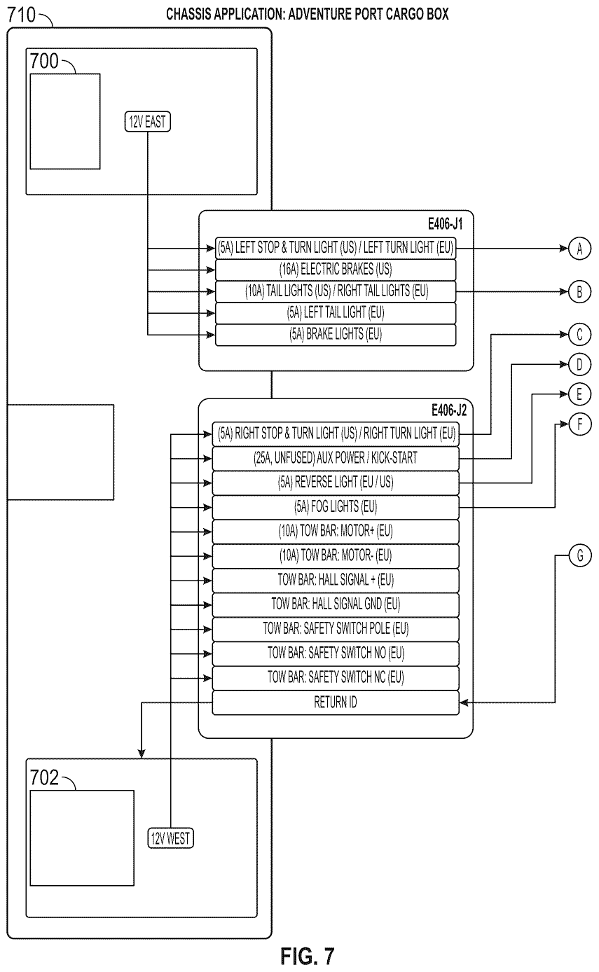

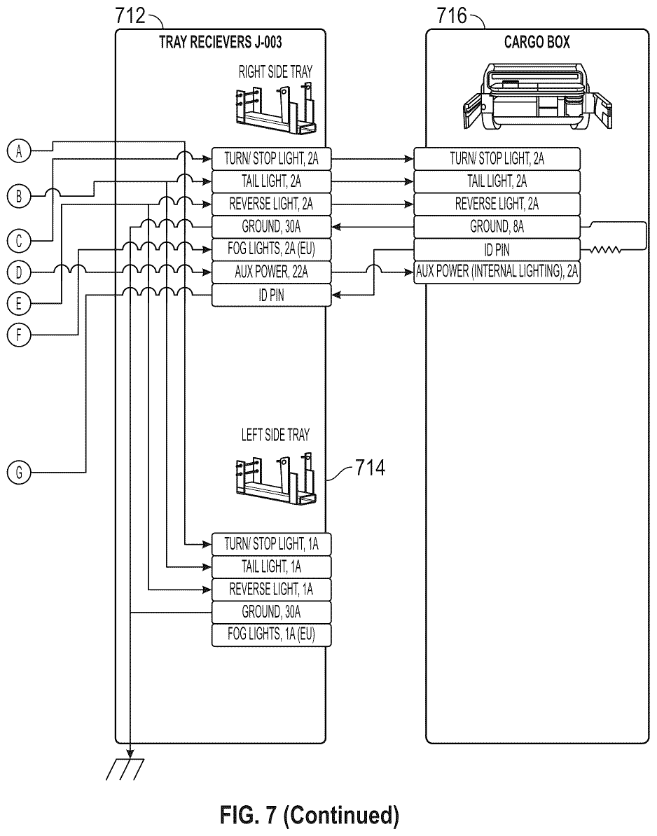

FIG. 7 shows illustrative signaling paths between a controller of a vehicle and a cargo box, in accordance with some embodiments of this disclosure. As shown in FIG. 7, zonal controller 710 may comprise zonal controller right 700 and zonal controller left 702. In some embodiments, zonal controller 710 may correspond to zonal controller 310 of FIG. 3, zonal controller right 700 may correspond to zonal controller right 300 of FIG. 3, and zonal controller left 702 may correspond to zonal controller left 302 of FIG. 3. As shown in FIG. 7, tray receivers 712 and 714 may provide an interface between zonal controller 710 and cargo box 716. For example, tray receivers 612 and 614 may plug into respective ports of the vehicle.

In the US implementation, zonal controller right 700 may provide a signal (e.g., 5 amps) from left stop and turn light element to turn/stop light element of left-side tray 714; zonal controller right 700 may provide a signal (e.g., 10 amps) from its tail lights element to tail lights elements of tray receivers 712 and 714, respectively; zonal controller left 702 may provide a signal from right stop and turn light element to turn/stop light element of tray receiver 712; zonal controller left 702 may provide a signal (e.g., 25 A, unfused) from its auxiliary power/kick-start element to auxiliary power (e.g., 22 A) element of right-side tray 712; zonal controller left 702 may provide a signal (e.g., 5 A) from its reverse light element to reverse light elements of right-side tray 712 and left-side tray 714; and zonal controller left 702 may receive an identification signal (e.g., of cargo box 716) from the ID pin of right-side tray 712.

In the EU implementation, zonal controller right 700 may provide a signal (e.g., 5 amps) from its left turn light element to turn/stop light element of left-side tray 714; zonal controller right 700 may provide a signal (e.g., 10 amps) from its right tail lights element to tail lights elements of tray receivers 712 and 714; zonal controller left 702 may provide a signal from its right turn light element to turn/stop light element of tray receiver 712; zonal controller left 702 may provide a signal (e.g., 25 A, unfused) from its auxiliary power/kick-start element to auxiliary power (e.g., 22 A) element of right-side tray 712; zonal controller left 702 may provide a signal (e.g., 5 A) from its reverse light element to reverse light elements of right-side tray 712 and left-side tray 714; zonal controller left 702 may provide a signal (e.g., 5 amps) from its fog lights element to the fog lights element of right-side tray 712; and zonal controller left 702 may receive an identification signal (e.g., of cargo box 716) from the ID pin of right-side tray 712.

As shown in FIG. 7, the corresponding elements or pins of right-side tray 712 may be coupled to the corresponding pins of cargo box 716. For example, this may allow power to be provided to cargo box 716, e.g., to provide turn/stop lights, reverse light, and taillights and/or other functionalities. For example, this may be beneficial if the cargo box is at least partially occluding the taillights of the vehicle to which it is connected and mounted on.

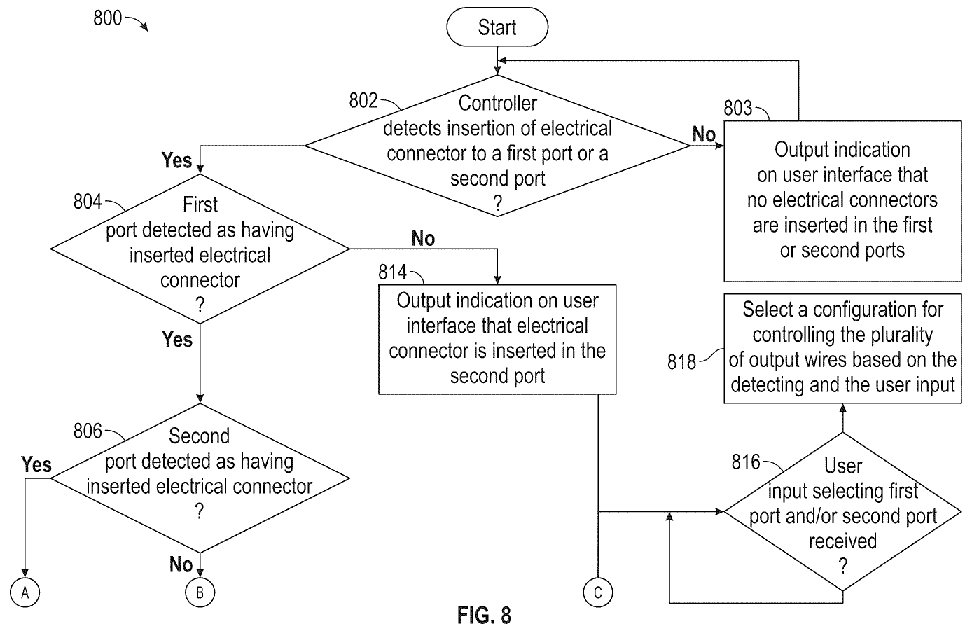

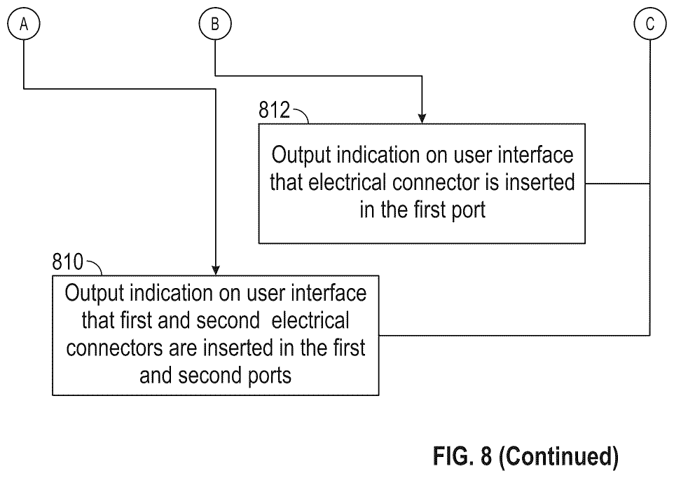

FIG. 8 shows illustrative an illustrative flowchart 800, in accordance with some embodiments of this disclosure. In some embodiments, process 800 may be performed by, e.g., zonal controller 110 of FIGS. 1A-1B, zonal controller 310 of FIG. 3, zonal controller 410 of FIG. 4, zonal controller 510 of FIG. 5, zonal controller 610 of FIG. 6, and/or zonal controller 710 of FIG. 7.

At 802, zonal controller 110 detects whether an electrical connector is inserted into first port 102 and other port(s) (e.g., second port 104 and/or third port 106) of vehicle 101. For example, a receiving port and accessory may include electrical terminals which engage each other when the accessory is secured to the port (e.g., via an electrical connector). In some embodiments, zonal controller 110 comprises a plurality of output wires, at least one of such output wires 105 being coupled to the first port 102 and other port(s) (e.g., second port 104 and/or third port 106). For example, towing port 102 and bicycle accessory ports 104 and 106 may share common circuitry. Zonal controller 110 may be configured to interface between differing standards, e.g., US 7-pin towing port and EU 13-pin towing port. In some embodiments, the output wires may correspond to any suitable combination of wires shown in FIGS. 3-7.

Zonal controller 110 of vehicle 101 may be configured to detect when an electrical connector is engaged or disengaged with first port 102, second port 104, and/or third port 106 of FIGS. 1A-1B, e.g., based on electrical signals measured from the electrical terminal. In some embodiments, more than one electrical terminal or pin of an electrical connector may contact corresponding electrical terminals of a port. For example, the use of multiple (e.g., 7-pins in the case of a US towing port) electrical contacts may allow a circuit to be completed, thus providing electrical feedback of engagement/disengagement. In some embodiments, based on the electrical signals measured, a type of accessory and/or a type of electrical connector may be detected by zonal controller 110, e.g., based on a resistance measurement corresponding to a particular type of accessory and/or electrical connector, and/or based on signals received at an identification pin (AIN). In some embodiments, one or more electrical terminals may contact corresponding electrical terminals of a port only when the plug is fully inserted, or otherwise connected. For example, the electrical terminals and corresponding electrical terminals may only line up and come in contact when the plug is fully inserted.

In some embodiments, port 102 may be of a different form factor than port 104 and 106. For example, an electrical connector capable of (e.g. properly shaped and sized for) being inserted into first port 102 may not be capable of being inserted into second and third ports 104 and 106 of FIGS. 1A-1B, and an electrical connector capable of (e.g. properly shaped and sized for) being inserted into second port 104 and/or third ports 106 may not be capable of being inserted into first port 102. In some embodiments, the form factors of one or more of such ports 102, 104, and 106 may be the same or similar.

At 803, if no electrical connector is detected (at 802) as inserted into the first port 102 or other port(s) (e.g., second or third port 104, 106), a controller (e.g., vehicle controller 120) may cause UI 200 to output an indication that no electrical connectors are inserted into any of the ports of vehicle 101.

At 804, based on the detecting at 802, zonal controller 110 detects whether first port 102 has an electrical connector inserted therein; if so, processing proceeds to 806; otherwise processing proceeds to 814. At 806, having detected that an electrical connector is inserted into first port 102, zonal controller 110 may further detect whether second port 104 (and/or third port 106) has an electrical connector inserted therein. If so, processing may proceed to 810; otherwise, processing may proceed to 812.

At 810, having detected that an electrical connector is detected as inserted into the first port 102 and other port(s) (e.g., second port 104 and/or third port 106), a controller (e.g., vehicle controller 120) may cause UI 200 to output an indication that an electrical connector is inserted into the first and such other port(s), and processing may proceed to 816. At 812, having detected that an electrical connector is detected as inserted into the first port, but an electrical connector is not inserted in other port(s) (e.g., second and/or third port), a controller (e.g., vehicle controller 120) may cause UI 200 to output an indication that an electrical connector is inserted in the first port, and processing may proceed to 816. At 814, having detected that an electrical connector is detected as inserted into the second and/or third port (but not the first port), a controller (e.g., vehicle controller 120) may cause UI 200 to output an indication that an electrical connector is inserted in the second port, and processing may proceed to 816.

At 816, zonal controller 110 may determine whether user input has been received via UI 200 of FIG. 2 requesting electric power to be provided to one or more of the ports 102, 104, and/or 106 having been detected to have an electrical connector inserted therein. In some embodiments, 816 (or other steps of FIG. 8, such as, for example steps 810, 812, and 814 related to providing output via a UI) may be optional, e.g., a UI may not be provided, or user input may not be requested or received via UI 200 prior to performing the processing indicate at step 818, or step 818 may be performed automatically regardless of inputs received from a user or outputs provided via the UI.

Based on the detecting of 802-814, and optionally the UI input of 816, zonal controller 110 may select a configuration for controlling the plurality of output wires based on the detecting and the user input. For example, if an electrical connector is only detected as being inserted in first port 102, zonal controller 110 may enable electric current to flow to an accessory connected to first port 102 via an electrical connector. As another example, if an electrical connector is only detected as being inserted in second port 104 and/or third port 106, zonal controller 110 may enable electric current to flow to second port 104 and/or third port 106. As another example, if electrical connectors are inserted into first port 102 and other port(s) (e.g., second port 104 and third port 106), zonal controller 110 may enable electric current to flow to first port 102 and may enable electric current to flow to second port 104 and third port. In some embodiments, electric current flows to each of the ports regardless of the detecting, e.g., based on the ports sharing common circuity. In some embodiments, one or more wires of the plurality of output wires may be connected to the first port and may not be connected to the second port and third port, to selectively provide current to the first port without providing such current to the second and third ports. In some embodiments, one or more wires of the plurality of output wires may be connected to the second and/or third port and may not be connected to the first port, to selectively provide current to the second and/or third port without providing such current to the first port.

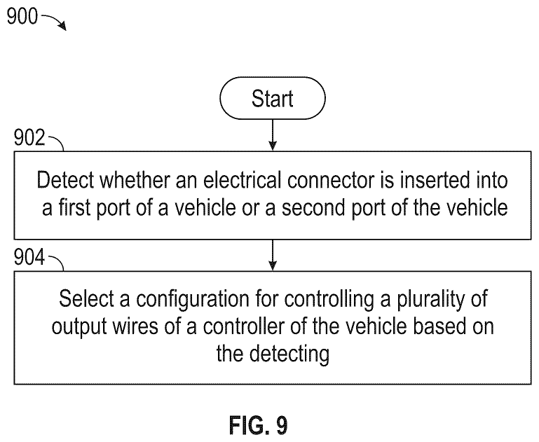

FIG. 9 shows illustrative an illustrative flowchart 900, in accordance with some embodiments of this disclosure. In some embodiments, process 900 may be performed by, e.g., zonal controller 110 of FIGS. 1A-1B, zonal controller 310 of FIG. 3, zonal controller 410 of FIG. 4, zonal controller 510 of FIG. 5, zonal controller 610 of FIG. 6, and/or zonal controller 710 of FIG. 7.

At 902, zonal controller 110 may detect whether an electrical connector is inserted into (e.g., engaged with) a first port 102 of vehicle 101 or a second port 104 and/or 106 of vehicle 101. Such detecting may be based on electrical signals measured from the electrical terminal. In some embodiments, more than one electrical terminal or pin of an electrical connector may contact corresponding electrical terminals of a port. For example, the use of multiple (e.g., 7-pins in the case of a US towing port) electrical contacts may allow a circuit to be completed, thus providing electrical feedback of engagement/disengagement. In some embodiments, based on the electrical signals measured, a type of accessory and/or a type of electrical connector may be detected by zonal controller 110, e.g., based on a resistance measurement corresponding to a particular type of accessory and/or electrical connector, and/or based on signals received at an identification pin (AIN). In some embodiments, one or more electrical terminals may contact corresponding electrical terminals of a port only when the plug is fully inserted, or otherwise connected. For example, the electrical terminals and corresponding electrical terminals may only line up and come in contact when the plug is fully inserted.

In some embodiments, port 102 may be of a different form factor than port 104 and 106. For example, an electrical connector capable of (e.g. properly shaped and sized for) being inserted into first port 102 may not be capable of being inserted into second and third ports 104 and 106 of FIGS. 1A-1B, and an electrical connector capable of (e.g. properly shaped and sized for) being inserted into second port 104 and/or third ports 106 may not be capable of being inserted into first port 102. In some embodiments, the form factors of one or more of such ports 102, 104, and 106 may be the same or similar.

At 904, zonal controller 110 may select a configuration for controlling a plurality of output wires 103 and 105 of zonal controller 110 of vehicle 101, based on the detecting at 902. For example, zonal controller 110 may determine that, for example, a first electrical connector is inserted into first port 102, e.g., a cable or harness connected to a trailer to be towed by vehicle 101 is coupled to first port 102, and based on such sensor data, zonal controller 110 may cause electric current to flow to first port 102 via output wire 105. On the other hand, zonal controller 110 may determine that, for example, a first electrical connector is inserted into second port 104 and/or third port 106, e.g., a cable or harness of a bike rack to be used to charge an electric bicycle, and based on such sensor data, zonal controller 110 may cause electric current to flow to second port 104 and/or third port 106 via output wire 105.

In some embodiments, upon detecting that an electrical connector is connected to each of first port 102 and second port 104 (and/or third port 106), zonal controller 110 may cause electric current to be simultaneously provided to each of first port 102 and second port 104 (and/or third port 106), via wire 103 and wire 105. For example, zonal controller 110 may cause a signal to split between the various ports 102, 104, and 106.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof.

We claim:

1. An apparatus comprising:
a first port located at an exterior of an vehicle, wherein the first port is of a first form factor;
a second port located at the exterior of the vehicle, wherein the second port is of a second form factor that is different from the first form factor; and
a controller comprising a plurality of output wires, wherein at least one of the plurality of output wires is coupled to the first port and the second port, and wherein the controller is configured to:
detect whether an electrical connector is inserted into the first port or the second port; and
select a configuration for controlling the plurality of output wires based on the detecting.

2. The apparatus of claim 1, wherein the controller is further configured to:
cause, in response to detecting that the electrical connector is inserted into the first port and based on the selected configuration, electric current to flow to an accessory connected to the first port via the at least one of the plurality of output wires.

3. The apparatus of claim 1, wherein the first port is a 7-pin towing port.

4. The apparatus of claim 1, wherein the first port is a 13-pin towing port.

5. The apparatus of claim 1, wherein the controller is further configured to:
cause, in response to detecting that the electrical connector is inserted into the second port and based on the selected configuration, electric current to flow to an accessory connected to the second port via the at least one of the plurality of output wires.

6. The apparatus of claim 1, wherein the second port is a bicycle accessory port.

7. The apparatus of claim 1, wherein the first port and the second port are located on a rear portion of the exterior of the vehicle.

8. The apparatus of claim 7, further comprising:
a third port located at the exterior of the vehicle, wherein the second port is a left-hand side bicycle accessory port, in relation to the rear portion of the exterior of the vehicle, and the third port is a right-hand side bicycle accessory port, in relation to the rear portion of the exterior of the vehicle.

9. The apparatus of claim 7, wherein:
the controller comprises a left-side controller and a right-side controller;
the left-side controller is configured to cause electric current to flow to a left-hand side of an accessory, in relation to the rear portion of the vehicle, via a first wire of the plurality of output wires; and
the right-side controller is configured to cause electric current to flow to a right-hand side of the accessory, in relation to the rear portion of the vehicle, via a second wire of the plurality of output wires.

10. The apparatus of claim 1, wherein the controller is further configured to cause, in response to detecting that a first electrical connector is inserted into the first port and that a second electrical connector is inserted into the second port, and based on the selected configuration:
electric current to flow to an accessory connected to the first port via a first wire of the plurality of output wires; and
electric current to flow to an accessory connected to the second port via a second wire of the plurality of output wires.

11. The apparatus of claim 1, wherein the controller is further configured to:
receive an indication of an input that is received via a user interface; and
select the configuration further based on receiving the indication of the input.

12. The apparatus of claim 1, wherein the second port is a cargo box.

13. A method comprising:
detecting whether an electrical connector is inserted into a first port of a vehicle or a second port of the vehicle, wherein:
the first port is located at an exterior of the vehicle, and the first port is of a first form factor;
the second port is located at the exterior of the vehicle, and the second port is of a second form factor that is different from the first form factor;
the vehicle comprises a controller, the controller comprising a plurality of output wires; and
at least one of the plurality of output wires is coupled to the first port and the second port; and
selecting a configuration for controlling the plurality of output wires based on the detecting.

14. The method of claim 13, further comprising:
causing, in response to detecting that the electrical connector is inserted into the first port and based on the selected configuration, electric current to flow to an accessory connected to the first port via the at least one of the plurality of output wires.

15. The method of claim 13, wherein the first port is a 7-pin towing port.

16. The method of claim 13, wherein the first port is a 13-pin towing port.

17. The method of claim 13, further comprising:
causing, in response to detecting that the electrical connector is inserted into the second port and based on the selected configuration, electric current to flow to an accessory connected to the second port via the at least one of the plurality of output wires.

18. The method of claim 13, wherein the second port is a bicycle accessory port.

19. The method of claim 13, wherein the first port and the second port are located on a rear portion of the exterior of the vehicle.

20. The method of claim 19, wherein the vehicle further comprises a third port located at the exterior of the vehicle, wherein the second port is a left-hand side bicycle accessory port, in relation to the rear portion of the exterior of the vehicle, and the third port is a right-hand side bicycle accessory port, in relation to the rear portion of the exterior of the vehicle.
